(19) United States
(12) Patent Application Publication
(10) Pub. No.: US 2023/0384089 A1
(43) Pub. Date: Nov. 30, 2023

(54) TWO-DIRECTIONAL INCLINATION SENSOR AND METHOD FOR MANUFACTURING THE SAME

(71) Applicant: Citpo Technologies Co., Ltd., TAIPEI (TW)

(72) Inventors: Shin-Chiuan Pan, TAIPEI (TW); Brian Huang, TAIPEI (TW); Tim Chen, TAIPEI (TW); Cindy Jheng, TAIPEI (TW); Green Ko, TAIPEI (TW); Chun-Yi Liao, TAIPEI (TW)

(21) Appl. No.: 18/323,814

(22) Filed: May 25, 2023

(30) Foreign Application Priority Data
May 27, 2022 (TW) 111119941

(51) Int. Cl. G01C 9/00; G01C 25/00

(52) U.S. Cl. CPC G01C 9/00; G01C 25/00

(57) ABSTRACT

Provided herein are a two-directional inclination sensor for sensing an inclination of a structure and a method for manufacturing the same. The two-directional inclination sensor includes a main body of a monolithic piece configured to be installed in the structure for sensing the inclination. The main body includes a first section, a second section, a first resilient device connected between the first section and the second section and susceptible of bending along a first direction, a third section including a single-piece weight, and a second resilient device connected between the second section and the third section and susceptible of bending along a second direction. The main body is formed by a machining process to remove parts of a monolithic blank.

### CROSS-REFERENCE TO RELATED APPLICATION AND CLAIM OF PRIORITY

The application claims the benefit of Taiwan Patent Application No. 111119941, filed on May 27, 2022, at the Taiwan Intellectual Property Office, the disclosures of which are incorporated herein in their entirety by reference.

### FIELD OF THE DISCLOSURE

The present disclosure generally is related to a two-directional inclination sensor and a method for manufacturing the same and, more particularly, to a two-directional inclination sensor for sensing an inclination of a subject and a method for manufacturing the two-directional inclination sensor.

### BACKGROUND OF THE DISCLOSURE

The present disclosure involves two technical categories: inclination measurement and optic fiber Bragg grating (FBG) sensing. Inclination measurement relates to measuring inclination variations relative to verticality by using electronic or mechanical means.

The optic fibers described herein have an elongated cylindrical structure that has pure silicon dioxide as its core. Generally, a single-mode optic fiber has a circular cross section with an interior diameter of 125 μm. The core is coated with acrylics with an overall diameter of 250 μm. A regular optic fiber can withstand a tensile strain up to 10,000με. A brief description of the principles of FBG sensing techniques commonly used today is provided as follows:

FIG. 1 illustrates the principles of light reflection from an optic fiber Bragg grating (FBG). As shown in FIG. 1, the manufacturing of an FBG involves exposing a 1-20 mm long optic fiber 100, which includes an optic fiber core 101 coated by an acrylic layer 102, under high energy ultraviolet light that causes permanent periodic variations of the refraction index in that part of the optic fiber 100. The section of the optic fiber 100 with refraction index variation at a period of A is called an FBG 103. When continuous and wide-band light 104 enters the optic fiber core 101 that contains the FBG 103, only light 105 with a special wavelength that meets the Bragg condition is reflected and the rest of the light 106 passes through the FBG 103. When the FBG 103 is subject to an external force or temperature variations to generate a strain (ε_{B}), the period of the grating Λ changes, causing the wavelength of the reflected light 105 from the FBG 103 to shift. The original wavelength of the reflected light 105 is λ_{B}, and its variation is Δλ_{B}. The relation between Δλ_{B} and ε_{B} can be defined by the following equation:

$$Δ {λ}_{B} - 0.74 {λ}_{B} {ε}_{B} \qquad ( 1 )$$

$$or$$

$${ε}_{B} = \frac{Δ {λ}_{B}}{( 0.74 {λ}_{B} )} .$$

λ_{B} of the FBG 103 that is commonly used is in a range from 1525 to 1575 nm, and the variation Δλ_{B} that can be identified by a typical FBG interrogator is 1 μm. According to Equation (1), Δλ_{B} of 1 μm corresponds to a strain ε_{E} that is slightly less than 10⁻⁶, making the FBG 103 a stable and sensitive strain gauge.

The current technologies that include electronic or MEMS sensing methods use electromagnetic and/or variations of vibration frequency or electrical resistance to determine the inclination variations in reference to gravity, and are referred to as an inclinometer probe (IP). The IP can be used alone to sense the inclination against gravity at a given location on a structure or in the ground. According to the needs, it is possible to use a pair of IPs to sense the inclination in mutually perpendicular directions simultaneously.

The IP has been used for decades to monitor the lateral ground displacement. FIG. 2 is a schematic diagram showing the use of an IP 201 to measure the lateral ground displacement distribution. In FIG. 2, a casing 202 with engraved channels 203 compatible with the IP 201 is inserted along a nearly vertical direction 204 into the ground to be monitored. The IP 201 with guide wheels 205 is then installed in the inclinometer casing 202 manually along the channels 203. Readings of inclination variation δθ of the IP 201 are taken at a constant interval L, where the relative inclination between the top and the bottom of that measurement section is L sin δθ. Assuming that the bottom of the inclinometer casing 202 remains still, the accumulated lateral displacement calculated from the bottom of the casing is ΣL sin δθ. If a two-directional IP is used, a single measurement can be used to determine the inclination or lateral displacement along two directions of the channels of the inclinometer casing. If a series of IPs with a constant interval of L are installed in the inclinometer casing, a lateral displacement profile of the ground or a monitored target based on the inclinometer casing can be monitored automatically on a long term basis. This technique is referred to as in-place inclinometry (IPI).

These conventional technologies, including IP and IPI, have been used for over half a century. Electronic sensors, when deployed in the field, especially when inserted underground, are prone to short circuits due to humidity or lightning strikes. Electronic signals tend to drift with time and thus lack long-term stability. FBGs and optic fibers are non-conductive, and their stability is not affected by humidity or lightning. FBGs use the wavelength of light to measure the strain and such measurement is independent from light intensity, which makes it very suitable for use as a sensing unit in IPI due to its long-term stability. FIG. 3 shows the use of FBGs as sensors and a combination of mechanical elements to form an IP (more particularly, an FBG IP). When the FBG IP is tilted, the weight 301 suspended by the linkage 302 rotates in reference to the rotation bearing 303. In this case, one FBG sensor 304 is tensioned and the other is compressed. By subtracting the tensile strain of one FBG sensor 304 from the compressive strain of the other FBG sensor 304, the amount of the IP inclination can be determined while simultaneously compensating for the temperature effects. By stacking two mutually perpendicular FBG IPs, it is possible to perform two-directional (x-x and y-y) measurement. It is also possible to automatically monitor a lateral ground displacement profile on a long term basis using a series of stacked FBG IPs inserted into an inclinometer casing, similar to the conventional electronic IPIs. However, the FBG IP shown in FIG. 3 involves many mechanical parts, which makes the assembly of and integrations with the FBG complicated, resulting in uneasy manufacture and high cost. When two FBG IPs are stacked, all components are doubled including the weight. Such an arrangement makes the sensor excessively long and heavy, which makes it hard to use.

Therefore, the inventor, in view of the shortcomings of conventional techniques, has come up with the idea of the disclosure, and finally developed a two-directional inclination sensor and a method for manufacturing the same.

### SUMMARY OF THE DISCLOSURE

One object of the present disclosure is to provide a two-directional inclination sensor for sensing an inclination of a structure. The two-directional inclination sensor includes a main body of a monolithic piece configured to be installed in the structure for sensing the inclination. The main body is integrally formed and sharing a single-piece weight, thus its mechanical complexity and total weight are significantly alleviated.

Another object of the present disclosure is to provide a method for manufacturing a two-directional inclination sensor for sensing an inclination of a structure. The two-directional inclination sensor includes a main body of a monolithic piece configured to be installed in the structure for sensing the inclination. The main body is integrally formed by a machining process to remove parts of a monolithic blank. Sharing a single-piece weight minimizes the work of manual assembly of mechanical components to maintain precision, stability and yield of products.

Still another object of the present disclosure is to provide a method for manufacturing a two-directional inclination sensor for sensing an inclination of a structure. Independently assembled pre-tensioned FBG's are inserted and fixed into a reserved space inside a main body of the two-directional inclination sensor using set screws. This arrangement offers flexibility in producing the two-directional inclination sensor while maintaining precision, stability and yield of products.

A further object of the present disclosure is to provide a method for manufacturing a two-directional inclination sensor for sensing an inclination of a structure. An independent resilient device is used for each of the two sensing directions. Notwithstanding the sharing of a common single-piece weight, the significant differences between the thickness and width of the resilient device make them sensitive only in a designated direction.

To achieve the foregoing objects, the present disclosure provides a method for manufacturing a two-directional inclination sensor for sensing an inclination of a structure, wherein the two-directional inclination sensor includes a main body configured to be installed in the structure for sensing the inclination. The method includes the steps of: providing a monolithic blank; and integrally forming the main body by a machining process to remove parts of the monolithic blank to comprise: a first section; a second section; a first resilient device connected between the first section and the second section and susceptible of bending along a first direction; a third section; and a second resilient device connected between the second section and the third section and susceptible of bending along a second direction.

The present disclosure further provides a two-directional inclination sensor for sensing an inclination of a structure, including: a main body of a monolithic piece configured to be installed in a structure or in-ground for sensing inclination. The main body includes a first section; a second section; a first resilient device connected between the first section and the second section and susceptible of bending along a first direction; a third section including a single-piece weight; and a second resilient device connected between the second section and the third section and susceptible of bending along a second direction.

The present disclosure further provides a two-directional inclination sensor for sensing inclination of a structure or in-ground, including: a main body configured to be installed in the structure for sensing the inclination. The main body includes a first section; a second section; a first resilient device connected between the first section and the second section and susceptible of bending along a first direction; a third section; and a second resilient device connected between the second section and the third section and susceptible of bending along a second direction; and a single-piece weight connected to the third section.

For further descriptions and advantages of the present disclosure, please refer to the subsequent drawings and embodiments, so as to understand the technical solutions of the present disclosure more clearly.

### BRIEF DESCRIPTION OF THE DRAWINGS

The above embodiments and advantages of the present disclosure will become more readily apparent to those ordinarily skilled in the art after reviewing the following detailed descriptions and accompanying drawings:

FIG. 1 is a schematic diagram showing the principle of light reflection from an FBG.

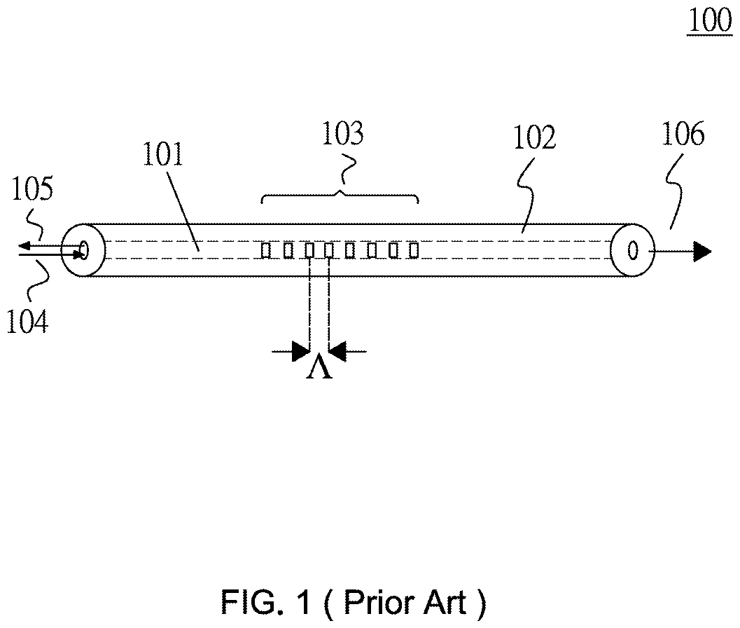

FIG. 2 is a schematic diagram showing the use of an inclinometer probe to measure the lateral ground displacement distribution.

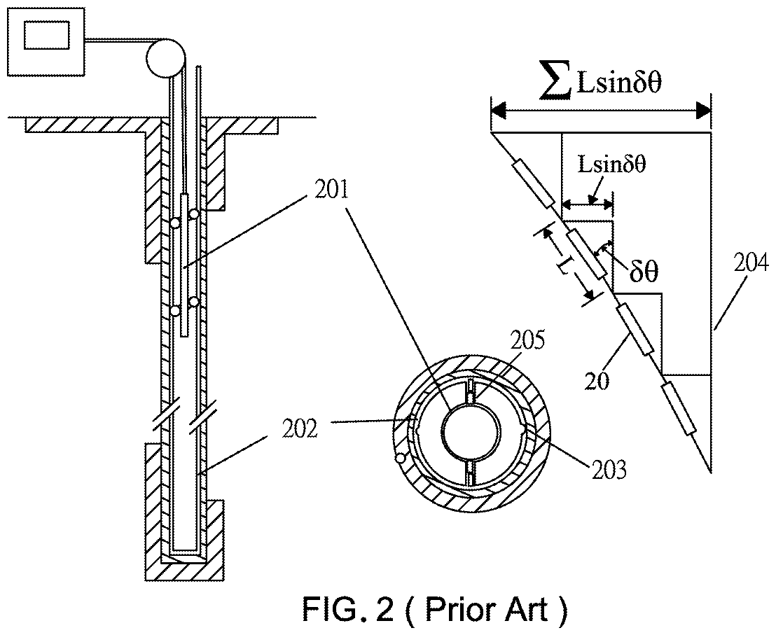

FIG. 3 is a schematic diagram showing a prior art FBG inclination sensor.

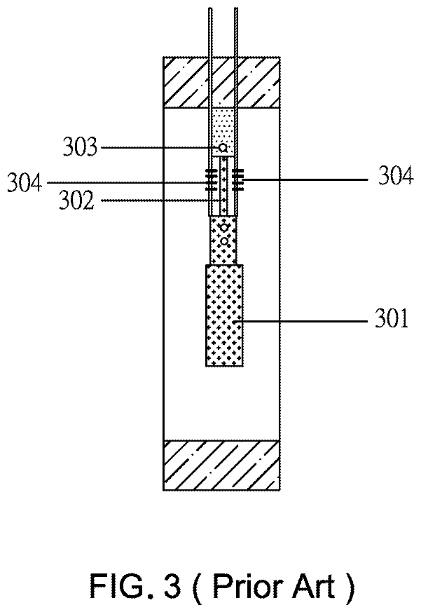

FIG. 4 is a schematic diagram showing the connection of an FBG sensor and an optic fiber at fixation ends.

FIG. 5A is a schematic diagram showing a two-directional inclination sensor according to a preferred embodiment of the present disclosure, where a first resilient device is susceptible of bending in the x-x direction.

FIG. 5B is a schematic diagram showing a two-directional inclination sensor according to a preferred embodiment of the present disclosure, where a second resilient device is susceptible of bending in the y-y direction.

FIG. 5C is a top view of a two-directional inclination sensor according to a preferred embodiment of the present disclosure.

FIG. 6A is a three-dimensional (3D) schematic diagram showing a monolithic blank according to a preferred embodiment of the present disclosure.

FIG. 6B is a 3D schematic diagram showing a two-directional inclination sensor according to a preferred embodiment of the present disclosure.

### DETAILED DESCRIPTION OF THE PREFERRED EMBODIMENTS

Please refer to all figures of the present disclosure when reading the following detailed description, wherein all Figures of the present disclosure demonstrate different embodiments of the present disclosure by showing examples, and help the skilled person in the art to understand how to implement the present disclosure. The present examples provide sufficient embodiments to demonstrate the spirit of the present disclosure, each embodiment does not conflict with the others, and new embodiments can be implemented through an arbitrary combination thereof, i.e., the present disclosure is not restricted to the embodiments disclosed in the present specification. Unless there are other restrictions defined in the specific example, the following definitions apply to the terms used throughout the specification.

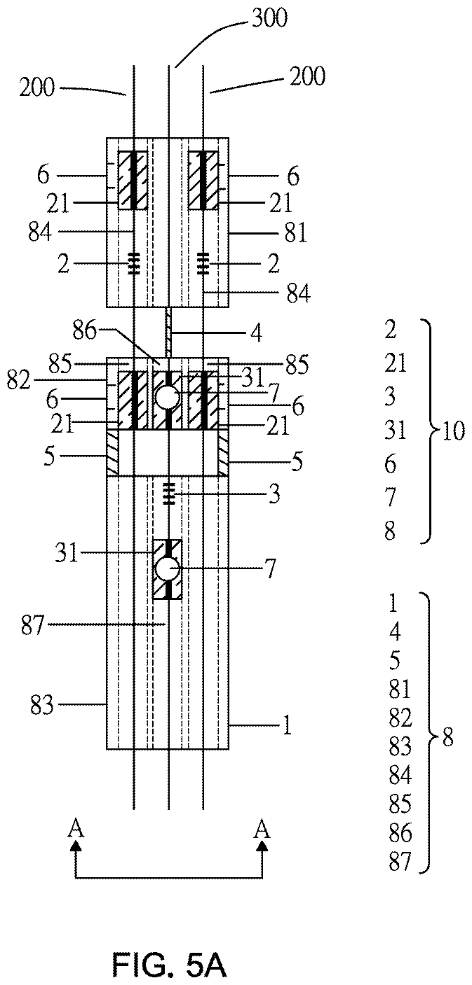

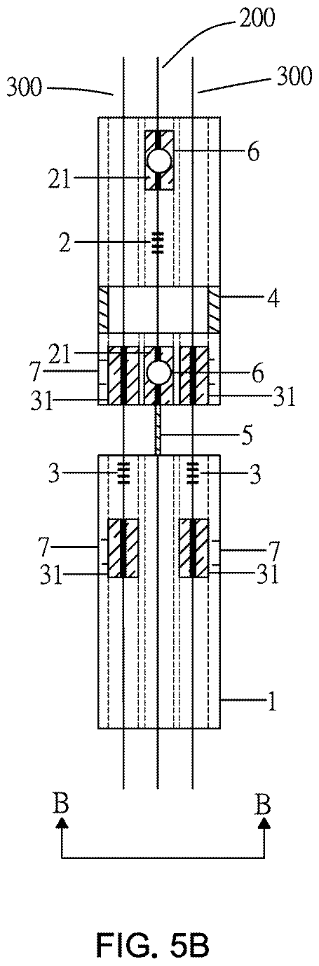

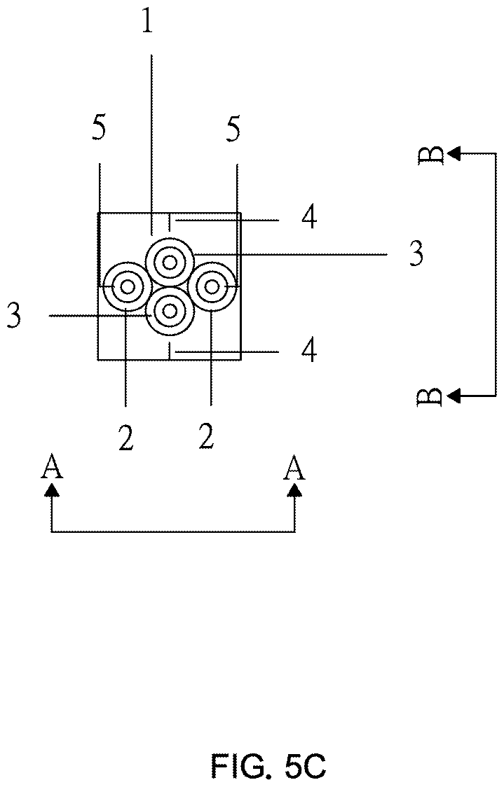

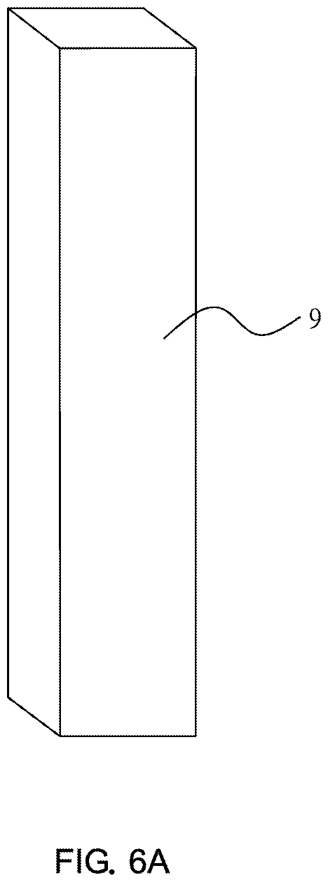

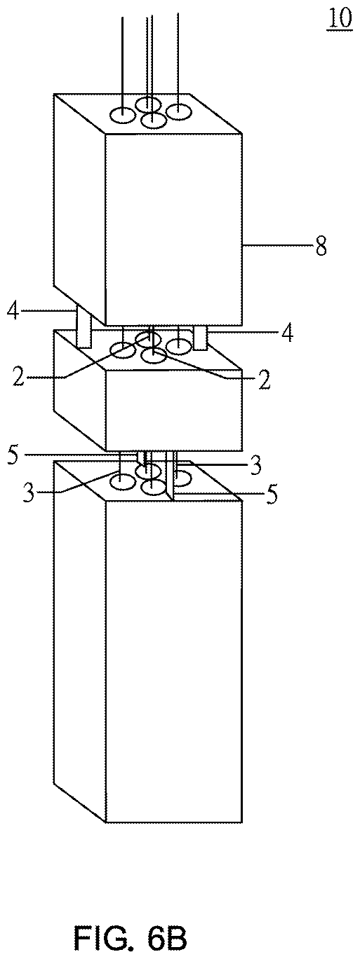

The present disclosure mainly provides a two-directional inclination sensor 10 as shown in FIG. 5A to FIG. 5C made from a monolithic blank 9 in FIG. 6A. The two-directional inclination sensor 10 uses a single-piece weight 1. Other than two first pre-tensioned FBG sensors 2 in a first direction and two second pre-tensioned FBG sensors 3 in a second direction, fixation ends 21 and 31 (4 for the two first pre-tensioned FBG sensors 2 and 4 for the two second pre-tensioned FBG sensors 3), corresponding set screws 6 configured to fix the two first pre-tensioned FBG sensors 2 in the first direction and set screws 7 configured to fix the two first pre-tensioned FBG sensors 2 in the second direction, the two-directional inclination sensor 10 is made from the monolithic blank 9 (as shown in FIG. 6A), with unwanted parts carved out mechanically leaving necessary spaces. In the present embodiment, the first direction is the x-x direction and the second direction is the y-y direction.

In some embodiments, a first resilient device 4 in the x-x direction as viewed from the A-A side of FIG. 5A has the thickness far less than the width as viewed from the B-B side of FIG. 5B, and a second resilient device 5 in the y-y direction as viewed from the A-A side of FIG. 5A has the width far more than the thickness as viewed from the B-B side of FIG. 5B. Therefore, when the single-piece weight 1 tilts in the x-x direction or the A-A plane, the first resilient device 4 in the x-x direction deflects significantly more than the second resilient device 5 in the y-y direction. On the other hand, when the single-piece weight 1 tilts in the y-y direction or the B-B plane, the second resilient device 5 in the y-y direction deflects significantly more than the first resilient device 4 in the x-x direction. The amount of deflection and thus inclination of the first resilient device 4 in the x-x direction and the second resilient device 5 in the y-y direction are determined by the two first pre-tensioned FBG sensors 2 in the x-x direction and the two second pre-tensioned FBG sensors 3 in the y-y direction, respectively. When the single-piece weight 1 tilts in both the x-x direction (or the A-A plane) and the y-y direction (or the B-B plane), the inclination measurements are vectorially summed to determine the combined inclination. In the present embodiment, the first resilient device 4 includes two first spring leaves on a first plane, and the second resilient device 5 includes two second spring leaves on a second plane. In one embodiment, the first plane and the second plane are perpendicular to each other.

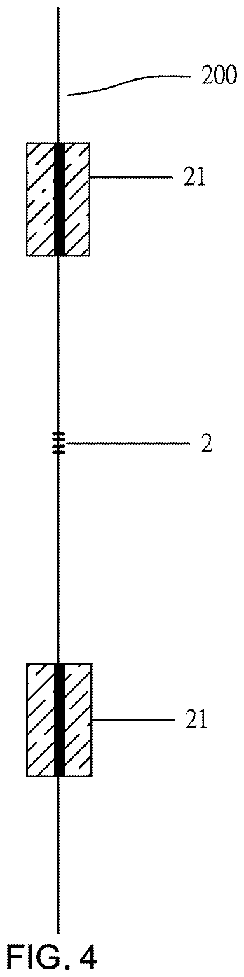

FIG. 4 is a schematic diagram showing the connection of an FBG sensor and an optic fiber at fixation ends. FIG. 4 is an example of the connection of the FBG sensor 2 and an optical fiber 200, and the connection of the FBG sensor 3 and an optic fiber 300 is the same as that of the FBG sensor 2 and an optical fiber 200. Independent from the fabrication of the main body 8 in FIG. 5A, a total of 4 FBG sensors, divided into two sets, with fixation ends as shown in FIG. 4 are made. The diameter/length of the fixation ends are compatible with the spaces 84, 85, 86 and 87 reserved in the main body 8. The distances between the fixation ends 21 and 31 are respectively compatible with the distances between the corresponding set screws 6 and 7 in the x-x and y-y directions. During fabrication, taking an optical fiber 200, as later shown in FIG. 5A and FIG. 5B, for example, the optical fiber 200 containing FBG sensors 2 is inserted through a hole at the center of two fixation ends 21. Then, the optical fiber 200 is epoxied to the fixation ends 21 leaving the FBG sensors 2 at the middle of the corresponding fixation ends 21. After the fixation ends 21 are disposed inside the main body 8, the two first pre-tensioned FBG sensors 2 in the x-x direction and the two second pre-tensioned FBG sensors 3 in the y-y direction along with their respective fixation ends 21 and 31 are fixed in the main body 8 by tightening the set screws 6 and 7 while maintaining a tension on the optical fibers 200 and 300. FIG. 6B shows the schematic diagram of a completed two-directional inclination sensor 10.

As shown in FIG. 5A to FIG. 5C, the monolithic blank for manufacturing the two-directional inclination sensor 10 may include stainless steel, aluminum or copper. The selected material and size are determined according to the planned range and resolution of measurements and expected weight of the single-piece weight 1 of the two-directional inclination sensor 10. Necessary machining methods that may include milling, lathing, drilling, and wire cutting are used to carve out the space to house the two first pre-tensioned FBG sensors 2 in the x-x direction and the two second pre-tensioned FBG sensors 3 in the y-y direction along with their respective set screws 6 and 7. The material around the first resilient device 4 in the x-x direction and the second resilient device 5 in the y-y direction is removed to yield the desired thickness, width, and length for the respective resilient devices 4 and 5.

The two first pre-tensioned FBG sensors 2 in the x-x direction and the two second pre-tensioned FBG sensors 3 in the y-y direction are inserted into the corresponding spaces 84, 85, 86 and 87 reserved in the main body 8, and then the set screws 6 are used to fix the two first pre-tensioned FBG sensors 2 in the x-x direction and the set screws 7 are used to fix the two second pre-tensioned FBG sensors 3 in the y-y direction.

FIG. 5A to FIG. 5C are schematic diagrams showing a two-directional inclination sensor according to a preferred embodiment of the present disclosure. In FIG. 5A, the two-directional inclination sensor 10 includes: a main body 8, two x-x direction FBG sensors 2 and two y-y direction FBG sensors 3. The main body 8 includes a single-piece weight 1, two x-x direction spring pieces 4, two y-y direction spring pieces 5, 4 set screws 6 for the FBG sensors 2 in the x-x direction, 4 set screws 7 for the FBG sensors 3 in the y-y direction, a first section 81, a second section 82, a third section 83, two first spaces 84 in the first section 81, two first spaces 85 in the second section 82, two second spaces 86 in the second section 82 and two second spaces 87 in the third section 83.

FIG. 6A is a three-dimensional (3D) schematic diagram showing a monolithic blank according to a preferred embodiment of the present disclosure. As shown in FIG. 6A, a 3D schematic diagram of a monolithic blank 9 is shown.

FIG. 6B is a 3D schematic diagram showing a two-directional inclination sensor according to a preferred embodiment of the present disclosure. In FIG. 6B, the two-directional inclination sensor 10 of the present disclosure includes a main body 8, two x-x direction FBG sensors 2, two y-y direction FBG sensors 3 and other components (as shown in FIG. 5A).

The present disclosure further provides a method for manufacturing a two-directional inclination sensor for sensing an inclination of a structure. In one embodiment, for example, the structure (not shown) may be at a certain point in the ground. Referring to FIG. 5A to FIG. 5C, the two-directional inclination sensor 10 includes a main body 8 configured to be installed in the structure for sensing the inclination. The method includes the following steps as described herein.

First, a monolithic blank 9 (as shown in FIG. 6A) is provided. In one embodiment, the monolithic blank 9 may include stainless steel, aluminum or copper. Then, a machining process is performed to remove unwanted parts of the monolithic blank 9 to integrally form the main body 8 that includes a first section 81, a second section 82, a first resilient device 4 connected between the first section 81 and the second section 82 and susceptible of bending along a first direction, a third section 83, and a second resilient device 5 connected between the second section 82 and the third section 83 and susceptible of bending along a second direction. In one embodiment, the machining process may be performed using a drilling machine, a milling machine or a wire cutting machine to remove the unwanted parts of the monolithic blank 9 in two first spaces 84 in the first section 81, two first spaces 85 in the second section 82, two second spaces 86 in the second section 82 and two second spaces 87 in the third section 83.

In one embodiment, the method may further include the following steps. Two first pre-tensioned FBG sensors 2 are placed between the first and second sections 81 and 82, and two ends of the two first pre-tensioned FBG sensors 2 are fixed respectively to the first spaces 84 and 85 of the first section 81 and the second section 82. Then, two second pre-tensioned FBG sensors 3 are placed between the second and third sections 82 and 83, and two ends of the two second pre-tensioned FBG sensors 3 are fixed respectively to the second spaces 86 and 87 of the second section 82 and the third section 83.

In one embodiment, the third section 83 is integrally extending a single-piece weight 1. Alternatively, the main body 8 may further include a single-piece weight 1 connected to the third section 83.

In one embodiment, the first resilient device 4 may include two first spring leaves on a first plane, and the second resilient device 5 may include two second spring leaves on a second plane. In one embodiment, the first plane and the second plane are perpendicular to each other.

In one embodiment, the method may further include the following steps. A first set of set screws 6 are provided to fix the two ends of the two first pre-tensioned FBG sensors 2 across the first section 81 and the second section 82. A second set of set screws 7 are provided to fix the two ends of the two second pre-tensioned FBG sensors 3 across the second section 82 and the third section 83.

The present disclosure provides a two-directional inclination sensor for sensing an inclination of a structure. In one embodiment, for example, the structure (not shown) may be at a certain point in the ground. Referring to FIG. 5A to FIG. 5C, the two-directional inclination sensor 10 includes a main body 8 of a monolithic piece configured to be installed in a structure or in-ground for sensing inclination. The main body 8 includes a first section 81, a second section 82, a first resilient device 4 connected between the first section 81 and the second section 82 and susceptible of bending along a first direction, a third section 83, and a second resilient device 5 connected between the second section 82 and the third section 83 and susceptible of bending along a second direction. In one embodiment, the third section 83 includes a single-piece weight 1. Alternatively, a single-piece weight 1 may be connected to the third section 83.

In one embodiment, the first section 81 has two first spaces 84, the second section 82 has two first spaces 85 and two second spaces 86, and the third section 83 has two second spaces 87. The two-directional inclination sensor 10 further includes two first pre-tensioned FBG sensors 2 placed between the first section 81 and the second section 82, and two second pre-tensioned FBG sensors 3 placed between the second section 82 and the third section 83. Two ends of the two first pre-tensioned FBG sensors 2 are fixed respectively to the first spaces 84 and 85 of the first section 81 and the second section 82. Two ends of the two second pre-tensioned FBG sensors 3 are fixed respectively to the second spaces 86 and 87 of the second section 82 and the third section 83.

In one embodiment, the two-directional inclination sensor 10 further includes a first set of set screws 6 and a second set of set screws 7. The first set of set screws 6 are configured to fix the two ends of the two first pre-tensioned FBG sensors 2 across the first section 81 and the second section 82. The second set of set screws 7 are configured to fix the two ends of the two second pre-tensioned FBG sensors 3 across the second section 82 and the third section 83.

In one embodiment, a first bending curvature of the first resilient device 4 and a second bending curvature of the second resilient device 5 are sensed by the two first pre-tensioned FBG sensors 2 and the two second pre-tensioned FBG sensors 3 to obtain an inclination along the first direction and an inclination along the second direction, respectively. When there are inclinations along both the first direction and the second direction, the inclination along the first direction and the inclination along the second direction are vectorially summed to determine a resultant inclination.

In one embodiment, the first resilient device 4 includes two first spring leaves on a first plane, and the second resilient device 5 includes two second spring leaves on a second plane. In one embodiment, the first plane and the second plane are perpendicular to each other. In one embodiment, a first bending curvature of the two first spring leaves and a second bending curvature of the two second spring leaves are sensed by the two first pre-tensioned FBG sensors and the two second pre-tensioned FBG sensors to obtain an inclination along an x-x direction and an inclination along a y-y direction, respectively. When there are inclinations along both the x-x direction and the y-y direction, the inclination along the x-x direction and the inclination along the y-y direction are vectorially summed to determine a resultant inclination.

While the disclosure has been described in terms of what is presently considered to be the most practical and preferred embodiments, it is to be understood that the disclosure need not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A method for manufacturing a two-directional inclination sensor for sensing an inclination of a structure or in-ground, wherein the two-directional inclination sensor includes a main body configured to be installed in the structure for sensing the inclination, the method comprising the steps of:
providing a monolithic blank; and
integrally forming the main body by a machining process to remove parts of the monolithic blank to comprise:
a first section;
a second section;
a first resilient device connected between the first section and the second section and susceptible of bending along a first direction;
a third section; and
a second resilient device connected between the second section and the third section and susceptible of bending along a second direction.

2. The method of claim 1, wherein the first section has two first spaces, the second section has two first spaces and two second spaces and the third section has two second spaces, the method further comprising:
placing two first pre-tensioned FBG sensors between the first and second sections and fixing two ends of the two first pre-tensioned FBG sensors respectively to the first spaces of the first section and the second section; and
placing two second pre-tensioned FBG sensors between the second and third sections and fixing two ends of the two second pre-tensioned FBG sensors respectively to the second spaces of the second section and the third section.

3. The method of claim 1, wherein the third section is integrally extending a single-piece weight.

4. The method of claim 1, wherein the main body further comprises a single-piece weight connected to the third section.

5. The method of claim 1, wherein the first resilient device comprises two first spring leaves on a first plane, and the second resilient device comprises two second spring leaves on a second plane.

6. The method of claim 5, wherein the first plane and the second plane are perpendicular to each other.

7. A two-directional inclination sensor for sensing an inclination of a structure or in-ground, comprising:
a main body of a monolithic piece configured to be installed for sensing the inclination, the main body comprising:
a first section;
a second section;
a first resilient device connected between the first section and the second section and susceptible of bending along a first direction;
a third section including a single-piece weight; and
a second resilient device connected between the second section and the third section and susceptible of bending along a second direction.

8. The two-directional inclination sensor of claim 7, wherein the first section has two first spaces, the second section has two first spaces and two second spaces and the third section has two second spaces, the two-directional inclination sensor further comprising:
two first pre-tensioned FBG sensors placed between the first and second sections, wherein two ends of the two first pre-tensioned FBG sensors are respectively fixed to the first spaces of the first section and the second section; and
two second pre-tensioned FBG sensors placed between the second and third sections, wherein two ends of the two second pre-tensioned FBG sensors are respectively fixed to the second spaces of the second section and the third section.

9. The two-directional inclination sensor of claim 8, further comprising a first set of set screws and a second set of set screws, wherein the first set of set screws are configured to fix the two ends of the two first pre-tensioned FBG sensors across the first section and the second section and the second set of set screws are configured to fix the two ends of the two second pre-tensioned FBG sensors across the second section and the third section.

10. The two-directional inclination sensor of claim 8, wherein:
a first bending curvature of the first resilient device and a second bending curvature of the second resilient device are sensed by the two first pre-tensioned FBG sensors and the two second pre-tensioned FBG sensors to obtain an inclination along the first direction and an inclination along the second direction, respectively; and
when there are inclinations along both the first direction and the second direction, the inclination along the first direction and the inclination along the second direction are vectorially summed to determine a resultant inclination.

11. The two-directional inclination sensor of claim 7, wherein the first resilient device comprises two first spring leaves on a first plane, and the second resilient device comprises two second spring leaves on a second plane.

12. The two-directional inclination sensor of claim 11, wherein the first plane and the second plane are perpendicular to each other.

13. The two-directional inclination sensor of claim 12, wherein:
a first bending curvature of the two first spring leaves and a second bending curvature of the two second spring leaves are sensed by the two first pre-tensioned FBG sensors and the two second pre-tensioned FBG sensors to obtain an inclination along an x-x direction and an inclination along a y-y direction, respectively; and
when there are inclinations along both the x-x direction and the y-y direction, the inclination along the x-x direction and the inclination along the y-y direction are vectorially summed to determine a resultant inclination.

14. A two-directional inclination sensor for sensing an inclination of a structure or in-ground, comprising:
a main body configured to be installed for sensing the inclination, the main body comprising:
a first section;
a second section;
a first resilient device connected between the first section and the second section and susceptible of bending along a first direction;
a third section; and
a second resilient device connected between the second section and the third section and susceptible of bending along a second direction; and
a single-piece weight connected to the third section.

15. The two-directional inclination sensor of claim 14, wherein the first section has two first spaces, the second section has two first spaces and two second pieces and the third section has two second spaces, the two-directional inclination sensor further comprising:
two first pre-tensioned FBG sensors placed between the first and second sections, wherein two ends of the two first pre-tensioned FBG sensors are respectively fixed across the first spaces of the first section and the second section; and
two second pre-tensioned FBG sensors placed between the second and third sections, wherein two ends of the two second pre-tensioned FBG sensors are respectively fixed across the second spaces of the second section and the third section.

16. The two-directional inclination sensor of claim 15, further comprising a first set of set screws and a second set of set screws, wherein the first set of set screws are configured to fix the two first pre-tensioned FBG sensors across the first section and the second section, and the second set of set screws are configured to fix the two second pre-tensioned FBG sensors across the second section and the third section.

17. The two-directional inclination sensor of claim 15, wherein:
a first bending curvature of the first resilient device and a second bending curvature of the second resilient device are sensed by the two first pre-tensioned FBG sensors and the two second pre-tensioned FBG sensors to obtain an inclination along the first direction and an inclination along the second direction, respectively; and
when there are inclinations along both the first direction and the second direction, the inclination along the first direction and the inclination along the second direction are vectorially summed to determine a resultant inclination.

18. The two-directional inclination sensor of claim 14, wherein the main body is of a monolithic piece, the first resilient device comprises two first spring leaves on a first plane, and the second resilient device comprises two second spring leaves on a second plane.

19. The two-directional inclination sensor of claim 18, wherein the first plane and the second plane are perpendicular to each other.

20. The two-directional inclination sensor of claim 19, wherein:
a first bending curvature of the two first spring leaves and a second bending curvature of the two second spring leaves are sensed by the two first pre-tensioned FBG sensors and the two second pre-tensioned FBG sensors to obtain an inclination along an x-x direction and an inclination along a y-y direction, respectively; and
when there are inclinations along both the x-x direction and the y-y direction, the inclination along the x-x direction and the inclination along the y-y direction are vectorially summed to determine a resultant inclination.
